(19) United States
(12) Patent Application Publication
(10) Pub. No.: US 2020/0219160 A1
(43) Pub. Date: Jul. 9, 2020

(54) SYSTEM FOR DISCOVERING AND PURCHASING SHOES, SPORTING APPARELS, CLOTHING OF ATHLETES/CELEBRITIES BEING SHOWCASED IN A LIVE BROADCAST

(71) Applicants: Bedis Zormati, New York, NY (US); Carlos Rodolfo Gallo, New York, NY (US)

(72) Inventors: Bedis Zormati, New York, NY (US); Carlos Rodolfo Gallo, New York, NY (US)

(21) Appl. No.: 16/736,548

(22) Filed: Jan. 7, 2020

Related U.S. Application Data
(60) Provisional application No. 62/789,119, filed on Jan. 7, 2019.

(51) Int. Cl. G06Q 30/06

(52) U.S. Cl. CPC G06Q 30/0623; G06Q 30/0641

(57) ABSTRACT

A system for real-time discovery and purchase of accessories of performers showcased in a live broadcast is provided. The system provides a series of user interfaces for selecting the type of performance and performers for further selecting wearable merchandize of the performers during the live performance. The series of user interfaces are an ordered combination that further facilitates the electronic discovery, storage and immediate or subsequent purchase of selected merchandise.

### CROSS-REFERENCE TO RELATED APPLICATION

This application claims the benefit of priority of U.S. provisional application No. 62/789,119, filed 7 Jan. 2019, the contents of which are herein incorporated by reference.

### BACKGROUND OF THE INVENTION

The present invention relates to sales and marketing systems and, more particularly, a system for real-time discovery and purchase of accessories of performers showcased in a live broadcast.

Most sport fans do not know the type or model of shoes, playwear, gear, accessories any athlete wears while watching their game live, much less hours or days later when shopping. Sports fans, though, think about shoes, gear, playwear and accessories they want to buy during a sporting event showcasing such athletes, which some marketers may call a peak level of marketing interest. Giving access to information about shoes, gear, playwear and accessories worn by athletes can create an impulsive and immediate buying desire that is most likely not as price sensitive as it may normally be, something that is of interest to commercial distributors and marketers. Furthermore, such a high level of convenience empowers a unique consumer experience that any marketer would be very interested in capturing. The same opportunity applies to the outfit, shoes, or accessories that a celebrity or socialite wears while they are out in the public eye.

As can be seen, there is a need for a system for real-time discovery and purchases of accessories of performers showcased in a live broadcast. The system of the present invention embodies an online platform enabling users to discover the type or model of shoes, playwear, gear, accessories any entertainer wears while watching a game live. Users of the platform are able to select any form of broadcast entertainment, include sports team or player, a specific game, or sporting event and immediately uncover the brand, style, model of shoes, playwear, gear or accessories worn by the entertainer at the time of the performance, or word later during the performer's personal life. The platform would also enable users to selectively choose different categories to be able to discover what outfit, shoes, or accessories a celebrity or socialite wears while they are out in the public eye.

Thereby the present invention provides users an impulsive purchase mechanism through making wearable merchandize immediately discoverable and ready for purchase in real time while an entertainer is performing. Marketers can utilize the present invention to generate sales of sporting playwear, shoes, outfit, gear and accessories that sports fans would not otherwise know about. The fact that the buying decision is made during a live performance while emotional engagement is at an apex (e.g., during a big-time sporting event) enhances the consumer experience and empowers the buying decision. The platform may also be utilized to promote and sell all outfits, shoes accessories worn by celebrities, and so the present invention could supply those celebrities with an additional advertising platform to promote their service and product providers.

### SUMMARY OF THE INVENTION

In one aspect of the present invention, a computer-implemented system for real-time discovery and purchase of accessories of performers broadcast in a live performance including the following: providing a first and second user interfaces for accessing and logging onto, respectively, the computer-implemented system; providing a third user interfaces for selecting a type of performance; providing a fourth user interface for selecting a subdivision of the type of performance (wherein a subdivision may be a league or conference within a larger type of performance); providing a fifth user interface for selecting a specific performance; providing a sixth user interface for and performers for further selecting one or more identifiable performers of the specific performance; and providing a seventh user interface for broadcasting the specific performance and identifying one or more wearable merchandize item of each identifiable performers worn during the specific performance, wherein the seventh user interface enables an input-output functionality for identifying one or more wearable merchandize item through haptic feedback with the seventh user interface, further including an eighth user interface for providing a plurality of electronic links to sellers of said one or more wearable merchandize; and a ninth user interface for providing retrievable storage of said one or more wearable merchandize and the plurality of electronic links.

These and other features, aspects and advantages of the present invention will become better understood with reference to the following drawings, description and claims.

### BRIEF DESCRIPTION OF THE DRAWINGS

FIG. 1A is a flowchart of an exemplary embodiment of the present invention;

FIG. 1B is a flowchart of an exemplary embodiment of the present invention; and

FIG. 1C is a flowchart of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a system for real-time discovery and purchase of accessories of performers showcased in a live broadcast. The system provides a series of user interfaces for selecting the type of performance and performers for further selecting wearable merchandize of the performers during the performances. The series of user interfaces are an ordered combination that further facilitates the electronic discovery, storage and immediate or subsequent purchase of selected merchandise.

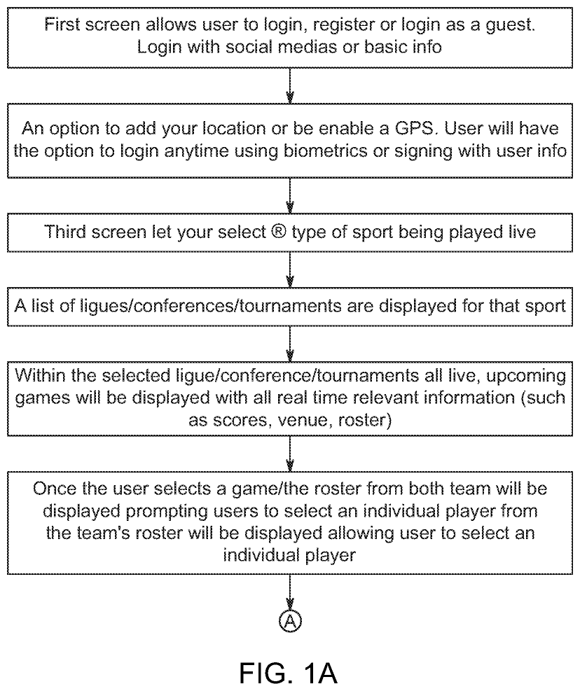

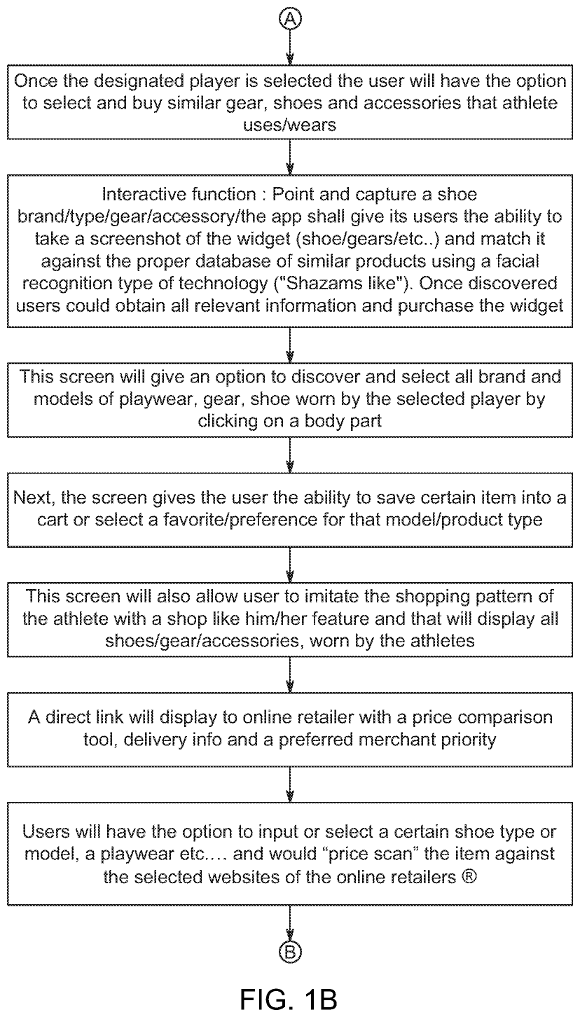

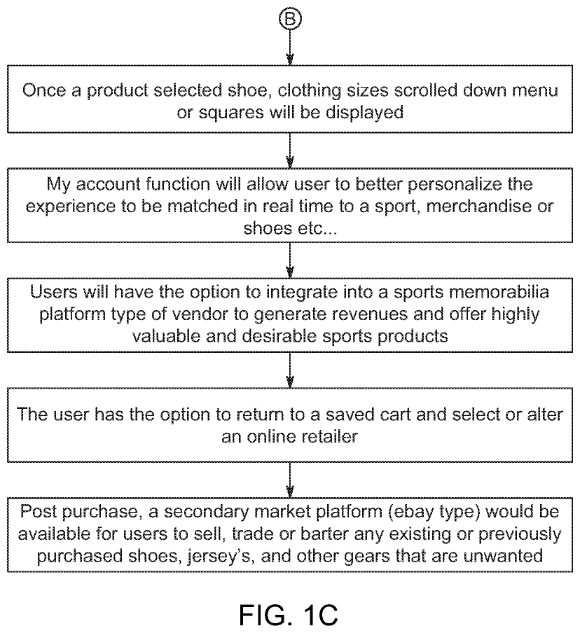

Referring now to FIGS. 1A through 1C, may include at least one computer with a user interface. The computer may include at least one processing unit coupled to a form of memory. The computer may include, but not limited to, a microprocessor, a server, a desktop, laptop, and smart device, such as, a tablet and smart phone. The computer includes a program product including a machine-readable program code for causing, when executed, the computer to perform steps. The program product may include software which may either be loaded onto the computer or accessed by the computer. The loaded software may include an application on a smart device. The software may be accessed by the computer using a web browser. The computer may access the software via the web browser using the internet, extranet, intranet, host server, internet cloud and the like.

The ordered combination of various ad hoc and automated tasks in the presently disclosed platform necessarily achieves technological improvements through the specific processes described more in detail below. In addition, the unconventional and unique aspects of these specific automation processes represent a sharp contrast to merely providing a well-known or routine environment for performing a manual or mental task. Furthermore, the live-performance-based system of the impulse purchasing method contemplated by the present invention is an inherent computer-based problem that inherently can only be solved by a computer implemented method and/or system.

Referring to FIGS. 1A through 1C, the platform of the present invention may provide first and second user interfaces allowing users to login, register or shop as a guest, including login functionality utilizing social medias or basic user information. An option to add one's location, possibly enabled via a GPS locator, may be offered.

A third user interface may be adapted to allow users to select a type of entertainment being played or performed live or other event being broadcast live. On a fourth user interface, a selectable list of associated leagues/conferences, for example, may be displayed on the third user interface if the type of entertainment is associated with a sport. Taking this example further, within the selected leagues/conference all live, upcoming games may be displayed with all real time relevant information through a fifth user interface. Once the user selects a team(s), a player or players from the team roster may be displayed allowing user to select an individual player, by way of a sixth user interface.

Once the designated player/entertainer/performer is selected the user will have the option to select and buy merchandise that the player/entertainer/performer is wearing, for instance the gear, shoes and accessories that an athlete uses. In a certain mode, a user may electronically select specific merchandize by utilizing their personal smart device as an input-output device viz-a-viz the sixth user interface that is displaying/broadcasting the live performance and the identified performer(s) therein.

A seventh user interface may give an option to discover and select all brand and model of playwear, gear, shoe worn by the selected player.

Another user interface display may prompt a user to save certain items into a cart or select a favorite/preference for that model/product type. The platform may be configured to imitate the shopping pattern of the athlete with a ‘shop like a star’ feature and that will display all gear, accessories, shoes worn by the athlete.

A direct link may be provided through a user interface to online retailers with a price comparison tool, delivery data and a preferred merchants' priorities. Thus, a user may retrievable store information discovered, researched and/or identified through the above-mentioned user interfaces. A user may have the option to login anytime using biometrics or signing with user information. The present invention may provide an account function will allow users to better personalize the experience to be matched in real time to a sport, merchandise, shoes, etc. The user has the option to return to a saved cart and select or alter an online retailer.

The platform may provide an initial interface enabling a user to select a location, sports venue, a sport type, a team and/or a player with the ultimate goal of selecting accessories of performers during a live sporting event or performance, such as the playwear, gear, shoes, and accessories worn by the athlete.

The real time game information along with the information of the playwear, gear, shoes and accessories worn by the athlete is an important function of the invention. Moreover, the ability for the user to be led into project consumer choices of the selected performers in another important function. In certain embodiments, a parallel platform may be adapted to allow users to discover and buy shoes, clothing and accessories and get live similar information such as a restaurant or venue visited by a VIP, celebrity, or socialites so that users can discover these socialite's lifestyles, wardrobe taste, shoes and accessories preferences as well as their favorite resorts, vacation spots, service providers, restaurants.

The computer-based data processing system and method described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A computer-implemented system for real-time discovery and purchase of accessories of performers broadcast in a live performance, comprising:
providing a first and second user interfaces for accessing and logging onto, respectively, the computer-implemented system;
providing a third user interfaces for selecting a type of performance;
providing a fourth user interface for selecting a subdivision of the type of performance;
providing a fifth user interface for selecting a specific performance;
providing a sixth user interface for and performers for further selecting one or more identifiable performers of the specific performance; and
providing a seventh user interface for broadcasting the specific performance and identifying one or more wearable merchandize item of each identifiable performers worn during the specific performance.

2. The computer-implemented system for real-time discovery and purchase of accessories of performers broadcast in a live performance of claim 1, wherein the seventh user interface enables an input-output functionality for identifying one or more wearable merchandize item through haptic feedback with the seventh user interface.

3. The computer-implemented system for real-time discovery and purchase of accessories of performers broadcast in a live performance of claim 1, further comprising an eighth user interface for providing a plurality of electronic links to sellers of said one or more wearable merchandize.

4. The computer-implemented system for real-time discovery and purchase of accessories of performers broadcast in a live performance of claim 3, further comprising a ninth user interface for providing retrievable storage of said one or more wearable merchandize and the plurality of electronic links.
